(19) United States
(12) Patent Application Publication
(10) Pub. No.: US 2026/0321503 A1
(43) Pub. Date: Oct. 15, 2026

(54) MULTILAYER CERAMIC CAPACITOR, MANUFACTURING METHOD FOR MULTILAYER CERAMIC CAPACITOR, AND MANUFACTURING METHOD FOR MOUNTING STRUCTURE OF MULTILAYER CERAMIC CAPACITOR

(71) Applicant: Murata Manufacturing Co., Ltd., Nagaokakyo-shi, Kyoto-fu (JP)

(72) Inventors: Yusuke MAKI, Nagaokakyo-shi (JP); Yukihiro FUJITA, Nagaokakyo-shi (JP); Ryutaro YAMATO, Nagaokakyo-shi (JP); Chihiro OKUTANI, Nagaokakyo-shi (JP)

(21) Appl. No.: 19/462,043

(22) Filed: Jan. 28, 2026

Related U.S. Application Data
(63) Continuation of application No. PCT/JP2024/030225, filed on Aug. 26, 2024.

(30) Foreign Application Priority Data
Aug. 30, 2023 (JP) 2023-139586

(51) Int. Cl. H01G 4/236; H01G 4/008; H01G 4/12; H01G 4/30; H01G 13/00

(52) U.S. Cl. CPC H01G 4/236; H01G 4/008; H01G 4/1218; H01G 4/1236; H01G 4/30; H01G 13/006

(57) ABSTRACT

A multilayer ceramic capacitor includes a capacitor body, a first outer electrode, and a second outer electrode. The first outer electrode includes a first base electrode layer and a first surface electrode layer. The first base electrode layer is on a first main surface of the capacitor body in a lamination direction and covers a first via conductor. The first surface electrode layer directly covers the first base electrode layer. The second outer electrode is located on the first main surface, covers a second via conductor, and is spaced apart from the first outer electrode. An outer surface of the first surface electrode layer extends from an edge of the first base electrode layer on the first main surface in a direction away from the first main surface.

### CROSS REFERENCE TO RELATED APPLICATIONS

This application claims the benefit of priority to Japanese Patent Application No. 2023-139586 filed on Aug. 30, 2023 and is a Continuation Application of PCT Application No. PCT/JP2024/030225 filed on Aug. 26, 2024. The entire contents of each application are hereby incorporated herein by reference.

### BACKGROUND OF THE INVENTION

### 1. Field of the Invention

The present invention relates to multilayer ceramic capacitors, manufacturing methods for multilayer ceramic capacitors, and manufacturing methods for mounting structures of multilayer ceramic capacitors.

### 2. Description of the Related Art

A known multilayer ceramic capacitor includes a plurality of via conductors and a plurality of external terminals respectively electrically connected to the via conductors.

For example, the multilayer capacitor described in Japanese Unexamined Patent Application Publication No. 07-201651 includes outer electrodes formed on at least a portion of each of front and rear main surfaces of a multilayer body including a dielectric and internal electrodes, in which internal and outer electrodes of the same polarity are connected to each other by a plurality of columnar connecting members, and the columnar connecting members (via conductors) are disposed at locations where magnetic fields generated by current flowing through the internal electrodes cancel each other out.

For example, Japanese Unexamined Patent Application Publication No. 2006-135333 describes a multilayer capacitor array that includes a capacitor body, first and second internal electrodes alternately disposed so as to face each other across a corresponding one of the layers of a multilayer dielectric layer, first external terminals and second external terminals formed on one or more surfaces of the upper and lower surfaces of the body, and first conductive via holes and second conductive via holes formed in the body in a lamination direction and respectively connected to the first external terminals and the second external terminals.

The multilayer ceramic capacitors described in Japanese Unexamined Patent Application Publication No. 07-201651 and Japanese Unexamined Patent Application Publication No. 2006-135333 are described as being capable of reducing an equivalent series inductance (ESL). However, there is still room for improvement in the reduction of the ESL of such multilayer ceramic capacitors.

### SUMMARY OF THE INVENTION

Example embodiments of the present invention provide multilayer ceramic capacitors, manufacturing method for multilayer ceramic capacitors, and manufacturing method for mounting structures of multilayer ceramic capacitors, which are each able to reduce equivalent series inductance (ESL) of a multilayer ceramic capacitor.

A multilayer ceramic capacitor according to an example embodiment of the present invention includes a capacitor body, a first outer electrode, and a second outer electrode. The capacitor body includes a dielectric layer, first internal electrode layers, second internal electrode layers, a first via conductor, and a second via conductor. The first internal electrode layers and the second internal electrode layers are alternately laminated in a lamination direction with the dielectric layer interposed between adjacent ones of the first internal electrode layers and the second internal electrode layers. The first via conductor is electrically connected to the first internal electrode layers. The first via conductor extends from an inside of the capacitor body to a first main surface. The first main surface is on one side of the capacitor body in a lamination direction. The second via conductor is electrically connected to the second internal electrode layers. The second via conductor extends from the inside of the capacitor body to the first main surface. The first outer electrode includes a first base electrode layer and a first surface electrode layer. The first base electrode layer is provided on the first main surface and covers the first via conductor. The first surface electrode layer directly covers the first base electrode layer. The second outer electrode is provided on the first main surface and covers the second via conductor and is spaced apart from the first outer electrode. An outer surface of the first surface electrode layer extends from an edge of the first base electrode layer on the first main surface in a direction away from the first main surface.

A manufacturing method for a multilayer ceramic capacitor according to an example embodiment of the present invention includes preparing a capacitor body including a dielectric layer, first internal electrode layers, second internal electrode layers, a first via conductor, and a second via conductor, in which the first internal electrode layers and the second internal electrode layers are alternately laminated in a lamination direction with the dielectric layer interposed between adjacent ones of the first internal electrode layers and the second internal electrode layers, the first via conductor is electrically connected to the first internal electrode layers and extends from an inside of the capacitor body to a first main surface that is on one side of the capacitor body in the lamination direction, and the second via conductor is electrically connected to the second internal electrode layers and extends from the inside of the capacitor body to the first main surface, providing a first outer electrode including a first base electrode layer on the first main surface so as to cover the first via conductor and a first surface electrode layer directly covering the first base electrode layer, and providing a second outer electrode on the first main surface so as to cover the second via conductor, the second outer electrode being spaced apart from the first outer electrode. The providing the first outer electrode includes forming the first base electrode layer, forming a first plating layer on the first base electrode layer by plating, heat-melting the first plating layer, and forming the first surface electrode layer by cooling the heat-melted first plating layer.

A multilayer ceramic capacitor according to an example embodiment of the present invention includes a capacitor body, a first outer electrode, and a second outer electrode. The capacitor body includes a dielectric layer, first internal electrode layers, second internal electrode layers, a first via conductor, and a second via conductor. The first internal electrode layers and the second internal electrode layers are alternately laminated in a lamination direction with the dielectric layer interposed between adjacent ones of the first internal electrode layers and the second internal electrode layers. The first via conductor is electrically connected to the first internal electrode layers and extends from an inside of the capacitor body to a first main surface. The first main surface is on one side of the capacitor body in the lamination direction. The second via conductor is electrically connected to the second internal electrode layers. The second via conductor extends from the inside of the capacitor body to the first main surface. The first outer electrode is on the first main surface and covers the first via conductor. The second outer electrode is on the first main surface and covers the second via conductor and is spaced apart from the first outer electrode. An outer surface of the first outer electrode extends from an edge of the first via conductor on the first main surface in a direction away from the first main surface.

A manufacturing method for a multilayer ceramic capacitor according to an example embodiment of the present invention includes preparing a capacitor body including a dielectric layer, first internal electrode layers, second internal electrode layers, a first via conductor, and a second via conductor, in which the first internal electrode layers and the second internal electrode layers are alternately laminated in a lamination direction with the dielectric layer interposed between adjacent ones of the first internal electrode layers and the second internal electrode layers, the first via conductor is electrically connected to the first internal electrode layers and extends from an inside of the capacitor body to a first main surface that is a one-side surface of the capacitor body in the lamination direction, and the second via conductor is electrically connected to the second internal electrode layers and extends from the inside of the capacitor body to the first main surface, providing a first outer electrode on the first main surface so as to cover the first via conductor, and providing a second outer electrode on the first main surface so as to cover the second via conductor, the second outer electrode being spaced apart from the first outer electrode. The providing the first outer electrode includes forming a first plating layer on the first via conductor on the first main surface by plating, heat-melting the first plating layer, and forming the first outer electrode by cooling the heat-melted first plating layer.

According to example embodiments of the present invention, equivalent series inductance (ESL) of each multilayer ceramic capacitor is further reduced.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a cross-sectional view showing a multilayer ceramic capacitor according to a first example embodiment of the present invention.

FIG. 2 is a cross-sectional view of the multilayer ceramic capacitor, taken along the line II-II in FIG. 1.

FIG. 3 is a cross-sectional view of the multilayer ceramic capacitor, taken along the line III-III in FIG. 1.

FIG. 4 is a cross-sectional view of the multilayer ceramic capacitor, taken along the line IV-IV in FIG. 1.

FIG. 5 is a partial cross-sectional view showing a first outer electrode and its surroundings of the multilayer ceramic capacitor according to the first example embodiment of the present invention.

FIG. 6A is a partial cross-sectional view showing a first outer electrode and its surroundings of a multilayer ceramic capacitor according to a first modification of an example embodiment of the present invention.

FIG. 6B is a partial cross-sectional view showing a first outer electrode and its surroundings of a multilayer ceramic capacitor according to a second modification of an example embodiment of the present invention.

FIG. 6C is a partial cross-sectional view showing a first outer electrode and its surroundings of a multilayer ceramic capacitor according to a third modification of an example embodiment of the present invention.

FIG. 6D is a partial cross-sectional view showing a first outer electrode and its surroundings of a multilayer ceramic capacitor according to a fourth modification of an example embodiment of the present invention.

FIG. 6E is a cross-sectional view of a multilayer ceramic capacitor according to a fifth modification of an example embodiment of the present invention, taken through a first internal electrode layer.

FIG. 6F is a cross-sectional view of the ceramic capacitor according to the fifth modification, taken through a second internal electrode layer.

FIG. 6G is a cross-sectional view of a multilayer ceramic capacitor according to a sixth modification of an example embodiment of the present invention, taken through a first internal electrode layer.

FIG. 6H is a cross-sectional view of the ceramic capacitor according to the sixth modification, taken through a second internal electrode layer.

FIG. 7 is a flowchart showing a manufacturing method for a multilayer ceramic capacitor according to an example embodiment of the present invention.

FIG. 8 is a schematic cross-sectional view showing a state immediately after a first plating layer is formed in a manufacturing method for a multilayer ceramic capacitor according to an example embodiment of the present invention.

FIG. 9 is a cross-sectional SEM image observed in a state immediately after a first plating layer is formed in an experimental example of manufacturing of a ceramic capacitor according to an example embodiment of the present invention.

FIG. 10 is a cross-sectional SEM image observed in a state where a first surface electrode layer is formed in an experimental example of manufacturing of a ceramic capacitor according to an example embodiment of the present invention.

FIG. 11 is a schematic cross-sectional view showing a state where the multilayer ceramic capacitor according to the first example embodiment of the present invention and an electronic component are prepared.

FIG. 12 is a schematic cross-sectional view showing a mounting structure of the multilayer ceramic capacitor according to the first example embodiment of the present invention.

FIG. 13 is a cross-sectional view showing a multilayer ceramic capacitor according to a second example embodiment of the present invention.

FIG. 14 is a cross-sectional view showing a multilayer ceramic capacitor according to a third example embodiment of the present invention.

FIG. 15 is a cross-sectional view showing a multilayer ceramic capacitor according to a fourth example embodiment of the present invention.

FIG. 16 is a partial cross-sectional view showing a first outer electrode and its surroundings of the multilayer ceramic capacitor according to the fourth example embodiment of the present invention.

FIG. 17 is a flowchart showing a manufacturing method for the multilayer ceramic capacitor according to the fourth example embodiment of the present invention.

FIG. 18 is a schematic cross-sectional view showing a state immediately after a first plating layer is formed in the manufacturing method for the multilayer ceramic capacitor according to the fourth example embodiment of the present invention.

FIG. 19 is a schematic cross-sectional view showing a state where the multilayer ceramic capacitor according to the fourth example embodiment of the present invention and an electronic component are prepared.

FIG. 20 is a schematic cross-sectional view showing a mounting structure of the multilayer ceramic capacitor according to the fourth example embodiment of the present invention.

### DETAILED DESCRIPTION OF THE EXAMPLE EMBODIMENTS

Hereinafter, multilayer ceramic capacitors, manufacturing methods for multilayer ceramic capacitors, and manufacturing methods for mounting structures of the multilayer ceramic capacitors according to example embodiments of the present invention will be described in detail with reference to the drawings. In the following description of the example embodiments, the same reference characters denote the same or corresponding portions in the drawings, and the description thereof will not be repeated.

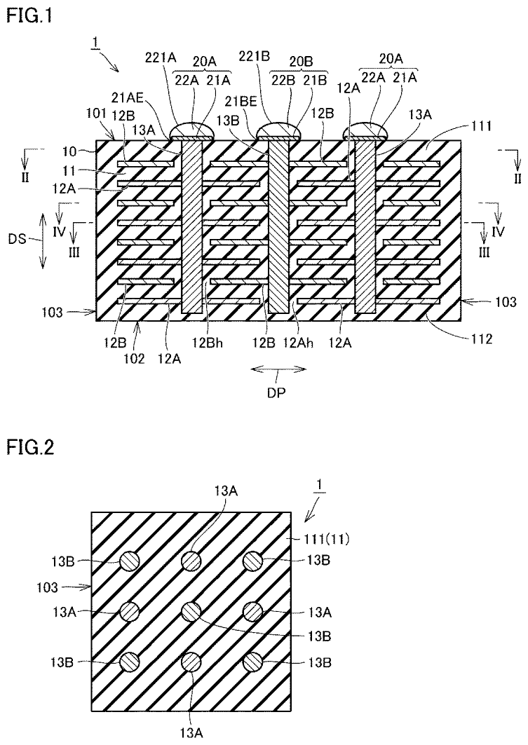

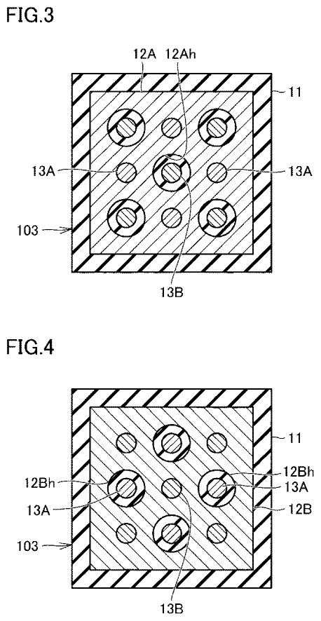

FIG. 1 is a cross-sectional view showing a multilayer ceramic capacitor according to a first example embodiment of the present invention. FIG. 2 is a cross-sectional view of the multilayer ceramic capacitor, taken along the line II-II in FIG. 1. FIG. 3 is a cross-sectional view of the multilayer ceramic capacitor, taken along the line III-III in FIG. 1. FIG. 4 is a cross-sectional view of the multilayer ceramic capacitor, taken along the line IV-IV in FIG. 1.

As shown in FIGS. 1 to 4, the multilayer ceramic capacitor 1 includes a capacitor body 10, first outer electrodes 20A, and second outer electrodes 20B.

The shape of the capacitor body 10 is not limited. In the present example embodiment, the capacitor body 10 has a rectangular or substantially rectangular parallelepiped shape. The rectangular or substantially rectangular parallelepiped shape is not a perfect rectangular parallelepiped shape but rather a shape that includes six surfaces and that can be regarded as a rectangular parallelepiped shape, such as, for example, a shape in which the corner portions and ridge portions of the rectangular parallelepiped shape are rounded.

The capacitor body 10 includes a first main surface 101, a second main surface 102, and a peripheral side surface 103. The first main surface 101 is on one side of the capacitor body 10 in a lamination direction DS. The second main surface 102 is a surface opposite to the first main surface 101 in the capacitor body 10. Each of the first main surface 101 and the second main surface 102 may have a rectangular or substantially rectangular outer shape when viewed in the lamination direction DS. The peripheral side surface 103 connects the first main surface 101 and the second main surface 102.

The dimensions of the capacitor body 10 are not limiting. For example, when viewed from the first main surface 101 side, the vertical dimension of the rectangle may be greater than or equal to about 0.3 mm and less than or equal to about 3.0 mm, the horizontal dimension of the rectangle may be greater than or equal to about 0.3 mm and less than or equal to about 3.0 mm, and the dimension in the lamination direction DS may be greater than or equal to about 50 μm and less than or equal to about 200 μm.

The capacitor body 10 includes a plurality of dielectric layers 11, a plurality of first internal electrode layers 12A, a plurality of second internal electrode layers 12B, a plurality of first via conductors 13A, and a plurality of second via conductors 13B.

The plurality of dielectric layers 11 include a first outer layer portion 111 and a second outer layer portion 112. The first outer layer portion 111 is the dielectric layer 11 located closest to the first main surface 101 among the plurality of dielectric layers 11. The first outer layer portion 111 defines a portion of the first main surface 101. The second outer layer portion 112 is the dielectric layer 11 located closest to the second main surface 102 among the plurality of dielectric layers 11. The second outer layer portion 112 defines an entirety or substantially an entirety of the second main surface 102. The peripheral side surface 103 is entirely defined by the plurality of dielectric layers 11 including the first outer layer portion 111 and the second outer layer portion 112.

The material of the dielectric layers 11 may be selected and is made of a ceramic material including, for example, BaTiO₃, CaTiO₃, SrTiO₃, SrZrO₃, or CaZrO₃, as a main component. A secondary component having a lower content than the main component and including, for example, Fe compounds, Cr compounds, Co compounds, or Ni compounds may be added to the main component.

The plurality of first internal electrode layers 12A and the plurality of second internal electrode layers 12B are alternately laminated one by one in the lamination direction DS with the dielectric layer 11 interposed between adjacent ones of the first internal electrode layers 12A and the second internal electrode layers 12B. In the multilayer ceramic capacitor 1, a capacitance is generated such that the first internal electrode layer 12A and the second internal electrode layer 12B face each other with the dielectric layer 11 interposed therebetween. Then, since the plurality of first internal electrode layers 12A and the plurality of second internal electrode layers 12B are laminated as described above, the multilayer ceramic capacitor 1 becomes a high-capacitance-density multilayer ceramic capacitor in which a plurality of capacitor functional units are arranged at high density.

In the present example embodiment, each of the plurality of first internal electrode layers 12A is provided integrally within the same layer (see FIG. 3). The first internal electrode layer 12A has a rectangular or substantially rectangular outer shape when viewed in the lamination direction DS. Each of the plurality of first internal electrode layers 12A includes a plurality of first through-holes 12Ah to insert the plurality of second via conductors 13B.

In the present example embodiment, each of the plurality of second internal electrode layers 12B is provided integrally within the same layer (see FIG. 4). The second internal electrode layer 12B has the same or substantially the same rectangular or substantially rectangular outer shape as the first internal electrode layer 12A when viewed in the lamination direction DS. Each of the plurality of second internal electrode layers 12B includes a plurality of second through-holes 12Bh to insert the plurality of first via conductors 13A (described later).

The materials of the first internal electrode layer 12A and the second internal electrode layer 12B may be selected, and include, for example, a metal, such as Ni, Cu, Ag, Pd, Pt, Fe, Ti, Cr, Sn, or Au, or an alloy including any one or more of these metals as a main component. The first internal electrode layer 12A and the second internal electrode layer 12B may include the same ceramic material as the dielectric ceramic included in the dielectric layer 11 as a common material. In that case, the proportion of the common material included in the first internal electrode layers 12A and the second internal electrode layers 12B is, for example, lower than or equal to about 20 vol %.

The thickness of each of the first internal electrode layers 12A and the second internal electrode layers 12B may be, for example, greater than or equal to about 0.3 μm and less than or equal to about 1.0 μm. The number of the first internal electrode layers 12A and the number of the second internal electrode layers 12B may be selected, and the number of both layers in total may be, for example, greater than or equal to 10 and less than or equal to 150.

Each of the plurality of first via conductors 13A is electrically connected to at least one of the plurality of first internal electrode layers 12A. In the present example embodiment, each of the plurality of first via conductors 13A is electrically connected to each of the plurality of first internal electrode layers 12A.

The plurality of first via conductors 13A extend from the inside of the capacitor body 10 to the first main surface 101. The plurality of first via conductors 13A extend along the lamination direction DS. The first via conductors 13A are not exposed from the second main surface 102. The plurality of first via conductors 13A are inserted through the second through-holes 12Bh provided in each of the plurality of second internal electrode layers 12B. For this reason, the plurality of first via conductors 13A are electrically insulated from the plurality of second internal electrode layers 12B.

Each of the plurality of second via conductors 13B is electrically connected to at least one of the plurality of second internal electrode layers 12B. In the present example embodiment, each of the plurality of second via conductors 13B is electrically connected to each of the plurality of second internal electrode layers 12B.

The plurality of second via conductors 13B extend from the inside of the capacitor body 10 to the first main surface 101. The plurality of second via conductors 13B extend along the lamination direction DS. The second via conductors 13B are not exposed from the second main surface 102. The plurality of second via conductors 13B are inserted through the second through-holes 12Bh provided in each of the plurality of first internal electrode layers 12A. For these reasons, the plurality of second via conductors 13B are electrically insulated from the plurality of first internal electrode layers 12A.

The shapes of the plurality of first via conductors 13A and second via conductors 13B may be, for example, a cylindrical shape. In that case, the diameters of the first via conductor 13A and the second via conductor 13B are, for example, greater than or equal to about 20 μm and less than or equal to about 150 μm. The distance between the adjacent first via conductor 13A and second via conductor 13B, more specifically, the distance between the center of the first via conductor 13A and the center of the second via conductor 13B, is, for example, greater than or equal to about 50 μm and less than or equal to about 500 μm.

The materials of the first via conductor 13A and the second via conductor 13B may be, for example, a metal, such as Ni, Cu, Ag, Pd, Pt, Fe, Ti, Cr, Sn, or Au, or an alloy including any one or more of these metals may be used as the materials of the first via conductor 13A and the second via conductor 13B. In the present example embodiment, the materials of the first via conductor 13A and the second via conductor 13B are preferably, for example, Ni or an alloy including Ni.

FIG. 5 is a partial cross-sectional view showing the first outer electrode and its surroundings of the multilayer ceramic capacitor according to the first example embodiment of the present invention. As shown in FIGS. 1 and 5, the plurality of first outer electrodes 20A are provided on the first main surface 101 so as to respectively cover the corresponding first via conductors 13A. More specifically, each of the plurality of first outer electrodes 20A covers the edge between the corresponding first via conductor 13A and the dielectric layer 11 (first outer layer portion 111) on the first main surface 101.

Each of the plurality of first outer electrodes 20A includes a first base electrode layer 21A and a first surface electrode layer 22A. The first base electrode layer 21A is provided on the first main surface 101 so as to cover the corresponding first via conductor 13A. Specifically, the first base electrode layer 21A covers the boundary between the corresponding first via conductor 13A and the dielectric layer 11 (first outer layer portion 111) on the first main surface 101.

The specific internal configuration of the first base electrode layer 21A is not limited. In the present example embodiment, the first base electrode layer 21A includes, for example, a fired electrode layer 211A, and a first base plating layer 212A and a second base plating layer 213A as a base plating layer.

The fired electrode layer 211A is provided on the first main surface 101 so as to directly cover the first via conductor 13A. Specifically, the fired electrode layer 211A covers the boundary between the corresponding first via conductor 13A and the dielectric layer 11 (first outer layer portion 111) on the first main surface 101. The fired electrode layer 211A preferably includes a metal of the same type as the metal included in the first via conductor 13A. In the present example embodiment, the material of the fired electrode layer 211A is preferably, for example, Ni or an alloy including Ni. A ceramic material is further added to the fired electrode layer 211A as a common material to improve the bonding strength with the dielectric layer 11.

The base plating layer covers the entire or substantially the entire portion of the surface of the fired electrode layer 211A not in contact with the first main surface 101. Specifically, the first base plating layer 212A directly covers the entire or substantially the entire portion of the surface of the fired electrode layer 211A not in contact with the first main surface 101. The second base plating layer 213A covers the opposite side of the first base plating layer 212A from the fired electrode layer 211A.

Examples of the materials of the base plating layer include Cu, Ni, or Au. In the present example embodiment, for example, the first base plating layer 212A includes Cu, and the second base plating layer 213A includes Ni.

The shape of the first base electrode layer 21A when viewed in the lamination direction DS is not limited. The shape of the first base electrode layer 21A when viewed in the lamination direction DS may be, for example, a circular shape. When the shape of the first base electrode layer 21A when viewed in the lamination direction DS is a circular or shape, the shapes of the fired electrode layer 211A, the first base plating layer 212A, and the second base plating layer 213A when viewed in the lamination direction DS are also circular shapes. The thickness of each of the fired electrode layer 211A, the first base plating layer 212A, and the second base plating layer 213A is, for example, greater than or equal to about 1 μm and less than or equal to about 10 μm.

The first surface electrode layer 22A directly covers the first base electrode layer 21A. The first surface electrode layer 22A covers the entire or substantially the entire portion of the first base electrode layer 21A not in contact with the first main surface 101.

An outer surface 221A of the first surface electrode layer 22A extends from an edge 21AE of the first base electrode layer 21A on the first main surface 101 away from the first main surface 101. The outer surface 221A of the first surface electrode layer 22A includes a first region 221Ap and a second region 221Aq in the lamination direction DS.

The first region 221Ap is in contact with the edge 21AE. The second region 221Aq is located on the opposite side of the first region 221Ap from the first main surface 101. The first region 221Ap extends such that the cross-sectional area of the first outer electrode 20A when viewed in the lamination direction DS increases with increasing distance from the first main surface 101. The second region 221Aq extends such that the cross-sectional area of the first outer electrode 20A when viewed in the lamination direction DS decreases with increasing distance from the first main surface 101.

The outer surface 221A of the first surface electrode layer 22A, more specifically, extends in a substantially curved shape. When the shape of the first base electrode layer 21A when viewed in the lamination direction DS is a circular or shape, the outer surface 221A of the first surface electrode layer 22A extends in a substantially spherical shape.

The thickness T1 of the first surface electrode layer 22A in the lamination direction DS at the central portion in the plane direction DP parallel or substantially parallel to the first main surface 101 is greater than the average thickness of the first surface electrode layer 22A that is the average of thickness of the first surface electrode layer 22A from an inner surface 222A, which is a surface in contact with the first base electrode layer 21A, to the outer surface 221A. In the present example embodiment, the central portion of the first surface electrode layer 22A in the plane direction DP refers to the central portion (center of gravity portion) when the first surface electrode layer 22A is viewed in the lamination direction DS. The thickness from the inner surface 222A to the outer surface 221A at a selected point on the inner surface 222A is the thickness of the first surface electrode layer 22A along a normal line when the normal line is imaginarily drawn relative to the inner surface 222A at that point. The average of a thickness from the inner surface 222A to the outer surface 221A is obtained as, for example, the average of thicknesses at five different points on the inner surface 222A.

The height dimension H of the first surface electrode layer 22A in the lamination direction DS from the first main surface 101 is, for example, greater than or equal to about 10 μm and less than or equal to about 20 μm. As the height dimension H of the first surface electrode layer 22A increases, the distance between the capacitor body 10 and an electronic component can be increased when the first surface electrode layer 22A is reflow soldered to the electronic component. Therefore, by setting the height dimension H to about 10 μm or greater, an underfill resin for filling the gap between the capacitor body 10 and the electronic component can be easily injected into the gap. However, the height dimension H of the first surface electrode layer 22A is not limited to the above range.

The width dimension W, which is the maximum dimension in the plane direction DP, of the first surface electrode layer 22A is set as needed so as to correspond to the dimension of the first via conductor 13A in the plane direction DP. When the outer shape of the first surface electrode layer 22A when viewed in the lamination direction DS is a circular or substantially circular shape, the width dimension W is the dimension of the diameter of the first surface electrode layer 22A when viewed in the lamination direction DS. The width dimension W of the first surface electrode layer 22A is, for example, less than or equal to about 120 μm, preferably less than or equal to about 100 μm, or more preferably less than or equal to about 75 μm. As the width dimension W of the first surface electrode layer 22A reduces, the center distance between the first outer electrode 20A and the second outer electrode 20B (described later) in the plane direction DP can be designed to be reduced. The lower limit of the width dimension W of the first surface electrode layer 22A is not limited. However, the width dimension W of the first surface electrode layer 22A may be, for example, greater than or equal to about 30 μm or may be greater than or equal to about 50 μm.

The ratio (W/H) that is a value obtained by dividing the width dimension W by the height dimension H of the first surface electrode layer 22A is, for example, preferably lower than or equal to about 3.0, or more preferably lower than or equal to about 1.5. As the ratio (W/H) decreases, the center distance between the first outer electrode 20A and the second outer electrode 20B (described later) in the plane direction DP can be designed to be reduced, and the distance between the capacitor body 10 and an electronic component can be increased when the first surface electrode layer 22A is reflow soldered to the electronic component.

The first surface electrode layer 22A is preferably made of a material having a melting point lower than the melting point of the material of the first base electrode layer 21A. As a result, when the first surface electrode layer 22A is reflow soldered to an electronic component, the shape of the first base electrode layer 21A is easily maintained. It is also easier to form the first surface electrode layer 22A into the above-described shape (details will be described later). The first surface electrode layer 22A is preferably made of, for example, Sn or an alloy including Sn and a metal such as Ag.

As shown in FIG. 1, the plurality of second outer electrodes 20B are provided and spaced apart from the plurality of first outer electrodes 20A. The plurality of second outer electrodes 20B are provided on the first main surface 101 so as to respectively cover the corresponding second via conductors 13B. More specifically, each of the plurality of second outer electrodes 20B covers the boundary between a corresponding one of the second via conductors 13B and the dielectric layer 11 (first outer layer portion 111) on the first main surface 101. The second outer electrode 20B when viewed from the corresponding second via conductor 13B can have the same or similar configuration as the first outer electrode 20A when viewed from the corresponding first via conductor 13A.

Each of the plurality of second outer electrodes 20B includes a second base electrode layer 21B and a second surface electrode layer 22B. The second base electrode layer 21B is provided on the first main surface 101 so as to cover the corresponding second via conductor 13B. Specifically, the second base electrode layer 21B covers the boundary between the corresponding second via conductor 13B and the dielectric layer 11 (first outer layer portion 111) on the first main surface 101. The second base electrode layer 21B of the second outer electrode 20B can have the same or similar configuration as the configuration that the first base electrode layer 21A of the first outer electrode 20A can have. In the present example embodiment, the second base electrode layer 21B includes, a fired electrode layer, a first base plating layer, and a second base plating layer (not shown), similar to those of the first base electrode layer 21A.

The second surface electrode layer 22B directly covers the second base electrode layer 21B. The second surface electrode layer 22B covers the entire or substantially the entire portion of the second base electrode layer 21B not in contact with the first main surface 101.

An outer surface 221B of the second surface electrode layer 22B extends from an edge 21BE of the second base electrode layer 21B on the first main surface 101 away from the first main surface 101. Furthermore, the second surface electrode layer 22B when viewed from the corresponding second base electrode layer 21B and second via conductor 13B can have the same or similar configuration as the first surface electrode layer 22A when viewed from the corresponding first base electrode layer 21A and first via conductor 13A.

In the present example embodiment, the height dimension H of the first surface electrode layer 22A (and the second surface electrode layer 22B) can have various values. In the present example embodiment, the first base electrode layer 21A (and the second base electrode layer 21B) can also have various layer structures. Here, multilayer ceramic capacitors according to modifications of the present example embodiment will be described. In the description of the modifications, the description of components the same as or similar to those of the first example embodiment will not be repeated.

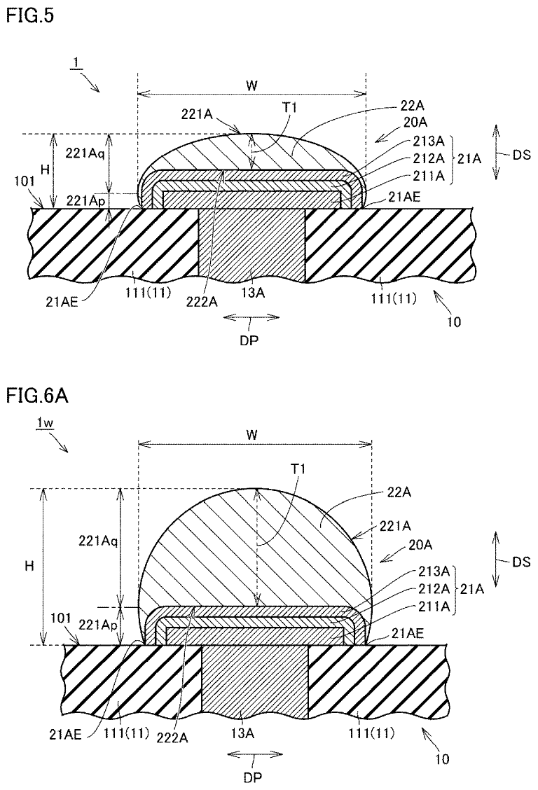

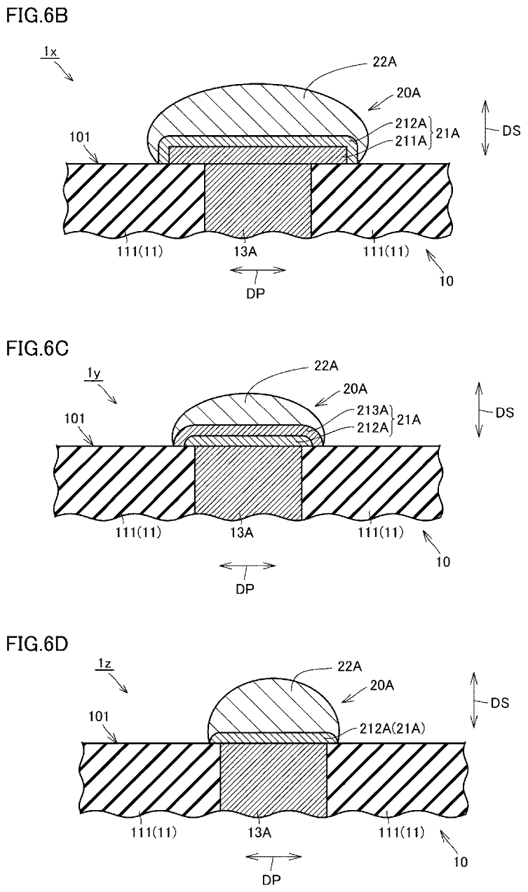

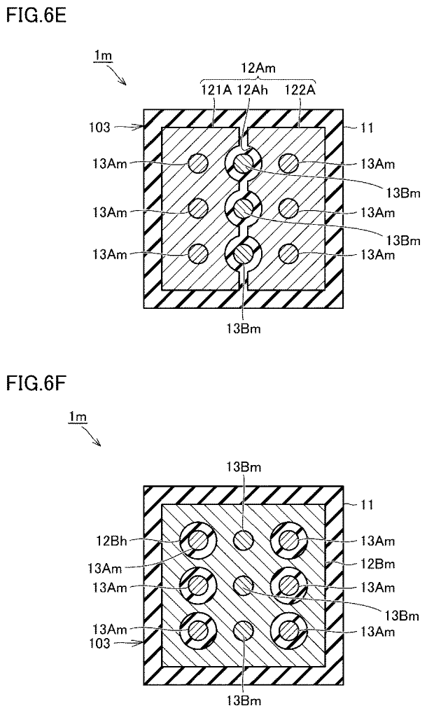

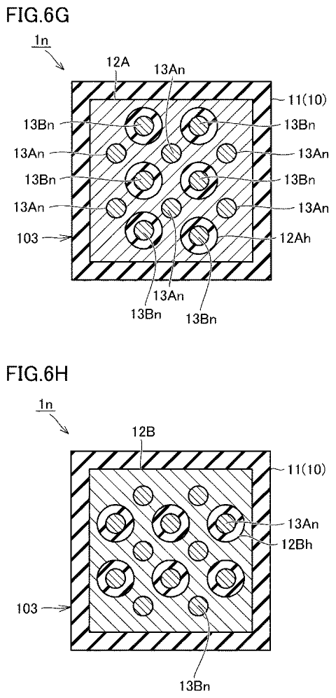

FIG. 6A is a partial cross-sectional view showing a first outer electrode and its surroundings of a multilayer ceramic capacitor according to a first modification of the present example embodiment. As shown in FIG. 6A, the multilayer ceramic capacitor 1w according to the first modification of the first example embodiment of the present invention has a height dimension H greater than the height dimension H of the first surface electrode layer 22A (see FIG. 5) in the present example embodiment.

FIG. 6B is a partial cross-sectional view showing a first outer electrode and its surroundings of a multilayer ceramic capacitor according to a second modification. As shown in FIG. 6B, in the multilayer ceramic capacitor 1x according to the second modification of the first example embodiment of the present invention, the base plating layer in the first base electrode layer 21A includes only the first base plating layer 212A. In this modification, the first surface electrode layer 22A directly covers the first base plating layer 212A.

FIG. 6C is a partial cross-sectional view showing a first outer electrode and its surroundings of a multilayer ceramic capacitor according to a third modification. As shown in FIG. 6C, in the multilayer ceramic capacitor 1y according to the third modification of the first example embodiment of the present invention, the first base electrode layer 21A does not include a fired electrode layer. In this modification, the first base electrode layer 21A includes only the first base plating layer 212A and the second base plating layer 213A. In this modification, the first base plating layer 212A is provided on the first main surface 101 so as to directly cover the first via conductor 13A.

FIG. 6D is a partial cross-sectional view showing a first outer electrode and its surroundings of a multilayer ceramic capacitor according to a fourth modification. As shown in FIG. 6D, in the multilayer ceramic capacitor 1z according to the fourth modification of the first example embodiment of the present invention, the first base electrode layer 21A includes only the first base plating layer 212A. For this reason, in this modification, the first base plating layer 212A is provided on the first main surface 101 so as to directly cover the first via conductor 13A, and the first surface electrode layer 22A directly covers the first base plating layer 212A.

Furthermore, in the present example embodiment, the first via conductors 13A and the second via conductors 13B are arranged alternately in both of one direction and a direction orthogonal or substantially orthogonal to the one direction when viewed in the lamination direction DS (see FIGS. 3 and 4). However, the arrays of the first via conductors 13A and the second via conductors 13B when viewed in the lamination direction DS are not limited to the above-described arrangement.

FIG. 6E is a cross-sectional view of a multilayer ceramic capacitor according to a fifth modification, taken through the first internal electrode layer. FIG. 6F is a cross-sectional view of the multilayer ceramic capacitor according to the fifth modification, taken through the second internal electrode layer. As shown in FIGS. 6E and 6F, in the multilayer ceramic capacitor 1m according to the fifth modification, when viewed in the lamination direction DS, a plurality of first via conductors 13Am are adjacent to each other and a plurality of second via conductors 13Bm are adjacent to each other in one direction. The first internal electrode layer 12Am includes a plurality of first internal electrode portions 121A, 122A that are spaced apart from each other within the same layer. In the present modification, only one second internal electrode layer 12Bm is located within the same layer, However, the second internal electrode layer 12Bm may also include a plurality of second internal electrode layers that are spaced apart from each other within the same layer.

FIG. 6G is a cross-sectional view of a multilayer ceramic capacitor according to a sixth modification, taken through the first internal electrode layer. FIG. 6H is a cross-sectional view of the multilayer ceramic capacitor according to the sixth modification, taken through the second internal electrode layer. As shown in FIGS. 6G and 6H, in the multilayer ceramic capacitor 1n according to the sixth modification, when viewed in the lamination direction DS, each of the direction in which the first via conductors 13An are arranged and the direction in which the second via conductors 13Bn are arranged intersects with one side of the peripheral side surface 103 extending in a rectangular or substantially rectangular shape.

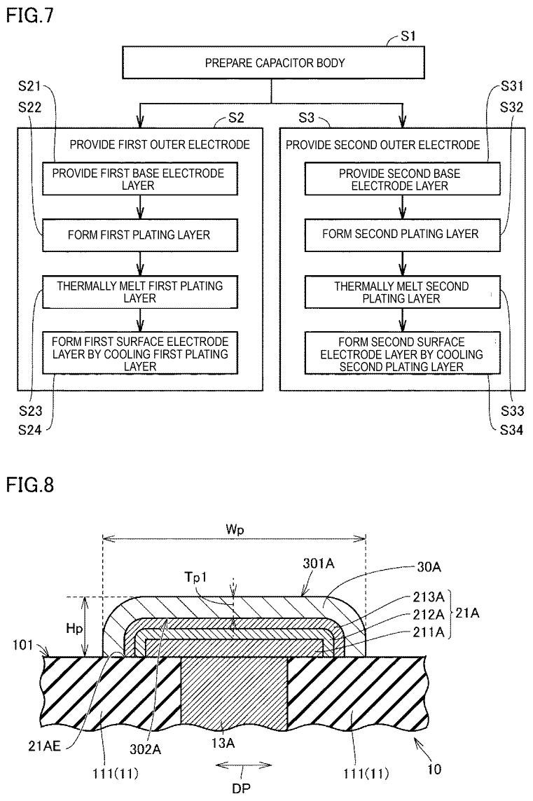

Next, an example of a manufacturing method for the multilayer ceramic capacitor according to the first example embodiment of the present invention will be described. FIG. 7 is a flowchart showing the manufacturing method for the multilayer ceramic capacitor according to the first example embodiment of the present invention. As shown in FIG. 7, the manufacturing method for the multilayer ceramic capacitor according to the first example embodiment of the present invention includes a step S1 of preparing a capacitor body, a step S2 of providing a first outer electrode, and a step S3 of providing a second outer electrode.

In the step S1 of preparing a capacitor body, the capacitor body 10 shown in FIG. 1 is prepared. A specific method of preparing the capacitor body 10 is not limited. In the present example embodiment, for example, in the step S1 of preparing a capacitor body, initially, a multilayer body is formed by stacking a plurality of ceramic green sheets corresponding to the plurality of dielectric layers 11 and conductive paste layers corresponding to the plurality of first internal electrode layers 12A and the plurality of second internal electrode layers 12B in a predetermined pattern. A plurality of through-holes that penetrate the multilayer body in the lamination direction are formed by laser irradiation, for example. Then, these through-holes are filled with conductive paste. As a result, a plurality of columnar conductive pastes corresponding to the plurality of first via conductors 13A and the plurality of second via conductors 13B of the capacitor body 10 are provided in the multilayer body. An outer layer ceramic green sheet corresponding to at least a portion of the second outer layer portion 112 is further laminated onto the multilayer body so as to cover one side of these columnar conductive pastes. As a result, on one side surface (a surface corresponding to the second main surface 102) of the multilayer body, the plurality of columnar conductive pastes are not exposed.

Then, the multilayer body in which the plurality of columnar conductive pastes and the outer layer ceramic green sheets are provided is fired. Thus, the capacitor body 10 is formed.

In the step S2 of providing a first outer electrode, the first outer electrode 20A shown in FIGS. 1 and 5 is provided on the first main surface 101 of the capacitor body 10. As shown in FIG. 7, the step S2 of providing a first outer electrode includes a step S21 of forming a first base electrode layer, a step S22 of forming a first plating layer, a step S23 of heat-melting the first plating layer, and a step S24 of forming a first surface electrode layer by cooling the first plating layer.

In the step S21 of forming a first base electrode layer, the first base electrode layer 21A shown in FIGS. 1 and 5 is provided on the main surface of the capacitor body 10. Initially, a conductive paste surface layer corresponding to the fired electrode layer 211A is provided on the first main surface 101 of the capacitor body 10 so as to cover the first via conductor 13A, and the fired electrode layer 211A is formed by further firing the conductive paste surface layer. The conductive paste surface layer may be provided on the multilayer body before the capacitor body 10 is fired. In this case, firing of the multilayer body and firing of the conductive paste surface layer can be performed at the same time.

After the fired electrode layer 211A is formed, the first base plating layer 212A is formed by performing plating treatment on the fired electrode layer 211A. Then, the second base plating layer 213A is formed by performing plating treatment on the first base plating layer 212A. These plating treatments may be, for example, plating treatments using barrel plating. In the third modification (see FIG. 6C) and the fourth modification (see FIG. 6D) of the present example embodiment, the first base plating layer 212A is formed by performing plating treatment on the first via conductor 13A. In this case, during the plating treatment, the first base plating layer 212A also grows in the plane direction DP. For this reason, the first base plating layer 212A is provided so as to cover the boundary between the dielectric layer 11 (first outer layer portion 111) and the first via conductor 13A.

FIG. 8 is a schematic cross-sectional view showing a state immediately after a first plating layer is formed in the manufacturing method for the multilayer ceramic capacitor according to the first example embodiment of the present invention. As shown in FIG. 8, in the step S22 of forming a first plating layer, the first plating layer 30A is formed on the first base electrode layer 21A by plating. Specifically, the first plating layer 30A is formed by performing plating treatment on the first base electrode layer 21A.

The first plating layer 30A is formed so as to cover the entire or substantially the entire portion of the first base electrode layer 21A not in contact with the first main surface 101. An outer surface 301A, which is a surface exposed to the outside, of the first plating layer 30A is spaced away from the edge 21AE of the first base electrode layer 21A on the first main surface 101. The thickness Tp1 of the first plating layer 30A in the lamination direction DS at the central portion in the plane direction DP is equal or substantially equal to the average thickness of the first plating layer 30A that is the average of the first plating layer 30A from an inner surface 302A, which is a surface in contact with the first base electrode layer 21A, to the outer surface 301A. Since the first plating layer 30A is formed so as to grow from the first base electrode layer 21A by plating, the thickness from the inner surface 302A to the outer surface 301A is substantially uniform. The average thickness of the first plating layer 30A is, for example, greater than or equal to about 3 μm and less than or equal to about 50 μm. The average thickness of the first plating layer 30A can be designed as needed in consideration of the distance between the center of the first via conductor 13A in the plane direction DP and the center of the second via conductor 13B in the plane direction DP and the distance by which the first via conductor 13A and the second via conductor 13B are spaced apart from each other.

In the step S23 of heat-melting the first plating layer, the first plating layer 30A formed as described above is heat-melted. As a result, the melted first plating layer 30A deforms into a curved shape due to its surface tension such that the area of the outer surface 301A approaches the minimum area for the volume of the first plating layer 30A, and more specifically deforms into a substantially spherical shape. Due to the deformation, the thickness Tp1 of the first plating layer 30A at the central portion increases, and the height dimension Hp of the first plating layer 30A in the lamination direction DS also increases. On the other hand, due to the deformation, the width dimension Wp that is the maximum dimension of the first plating layer 30A in the plane direction DP reduces. The bonding strength between the first plating layer 30A and the first outer layer portion 111 is relatively low, and the bonding strength between the first plating layer 30A and the first base electrode layer 21A is relatively high. For this reason, the outer surface 301A of the first plating layer 30A deforms so as to extend from the edge 21AE of the first base electrode layer 21A on the first main surface 101 relative to the first main surface 101.

Then, in the step S24 of forming a first surface electrode layer by cooling the first plating layer, the first plating layer 30A melted and deformed as described above is cooled and solidified. As a result, the first surface electrode layer 22A as shown in FIGS. 1 and 5 is formed. Therefore, the average thickness of the first surface electrode layer 22A, the thickness T1 at the central portion, the height dimension H, the width dimension W, and the like, can be controlled by adjusting the average thickness of the first plating layer 30A.

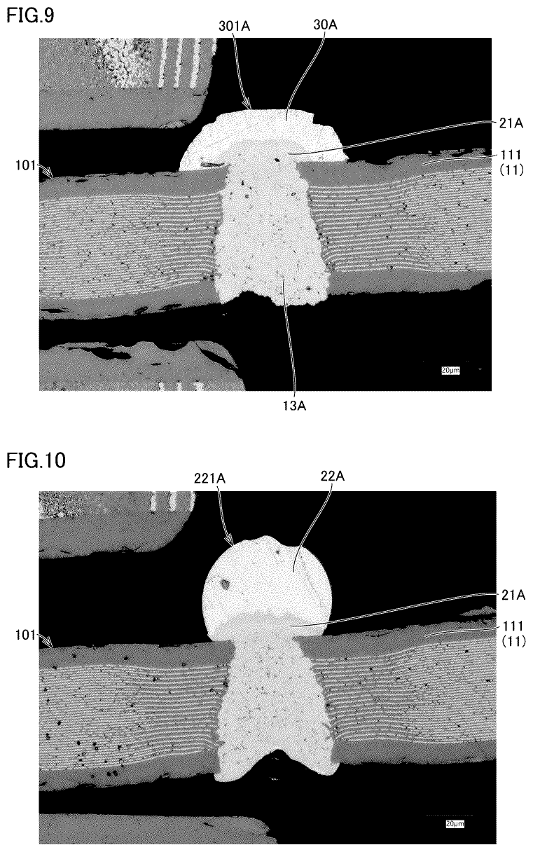

Here, the first plating layer 30A and the first surface electrode layer 22A will be described while showing an experimental example of the multilayer ceramic capacitor according to the present example embodiment. FIG. 9 is a cross-sectional SEM image observed in a state immediately after a first plating layer is formed in the experimental example of manufacturing of the multilayer ceramic capacitor according to the first example embodiment of the present invention. FIG. 10 is a cross-sectional SEM image observed in a state where a first surface electrode layer is formed in an experimental example of manufacturing of the multilayer ceramic capacitor according to the first example embodiment of the present invention. In FIGS. 9 and 10, the reference signs corresponding to the reference signs assigned in the description of the multilayer ceramic capacitor 1 according to the first example embodiment of the present invention are assigned.

As shown in FIGS. 9 and 10, the outer surface 301A of the first plating layer 30A deforms into a substantially spherical shape as a result of melting of the first plating layer 30A, and, furthermore, the melted first plating layer 30A is cooled to solidify, with the result that the first surface electrode layer 22A of which the outer surface 221A has a substantially spherical shape is formed.

Therefore, in the present example embodiment, the width dimension W of the first surface electrode layer 22A is less than the width dimension Wp of the first plating layer 30A before being heat-melted. The height dimension H of the first surface electrode layer 22A is greater than the height dimension Hp of the first plating layer 30A before being heat-melted. The thickness T1 of the first surface electrode layer 22A at the central portion is thicker than the thickness Tp1 of the first plating layer 30A at the central portion before being heat-melted. The ratio (W/H) of the first surface electrode layer 22A is lower than the ratio (Wp/Hp) that is a value obtained by dividing the width dimension Wp by the height dimension Hp of the first plating layer 30A before being heat-melted.

As the dimension of the first base electrode layer 21A in the plane direction DP reduces, the difference between the height dimension H of the first surface electrode layer 22A and the height dimension Hp of the first plating layer 30A increases. As the thickness Tp1 of the first plating layer 30A at the central portion before being heat-melted increases, the height dimension H of the first surface electrode layer 22A increases. Heating and cooling conditions in the above step S33 and the above step S34 can be adjusted as needed using the material of the first plating layer 30A (first surface electrode layer 22A). Similar conditions to solder reflow conditions in accordance with IPC/J-STD can be adopted as the heating and cooling conditions. A peak temperature in the above step S33 is, for example, about 260 °C

In the step S3 of providing a second outer electrode, the second outer electrode 20B shown in FIG. 1 is provided on the first main surface 101 of the capacitor body 10. As shown in FIG. 7, the step S3 of providing a second outer electrode includes a step S31 of forming a second base electrode layer, a step S32 of forming a second plating layer, a step S33 of heat-melting the second plating layer, and a step S34 of forming a second surface electrode layer by cooling the second plating layer.

The step S3 of providing a second outer electrode may be performed simultaneously with the step S2 of providing a first outer electrode. Specifically, the step S31 of forming a second base electrode layer is performed at the same time with the step S21 of forming a first base electrode layer. The step S32 of forming a second plating layer is performed at the same time with the step S22 of forming a first plating layer. The step S33 of heat-melting the second plating layer is performed at the same time with the step S23 of heat-melting the first plating layer. The step S34 of forming a second surface electrode layer by cooling the second plating layer is performed at the same time with the step S24 of forming a first surface electrode layer by cooling the first plating layer.

In the step S31 of forming a second base electrode layer, the second base electrode layer 21B shown in FIGS. 1 and 5 is provided on the main surface of the capacitor body 10. The same or substantially the same method as the method of forming the first base electrode layer 21A when viewed from the first via conductor 13A can be used as a method of forming the second base electrode layer 21B when viewed from the corresponding second via conductor 13B.

In the step S32 of forming a second plating layer, a second plating layer can be formed on the second base electrode layer 21B using the same or substantially the same method as the method of forming the first plating layer 30A on the first base electrode layer 21A. Heating conditions of the step S33 of heat-melting the second plating layer may be the same or substantially the same as heating conditions of the step S23 of heat-melting the first plating layer. As a result, the second plating layer also deforms similarly to the first plating layer 30A. Conditions for cooling the heat-melted second plating layer in the step S34 of forming the second surface electrode layer 22B by cooling the second plating layer may be the same as cooling conditions in the step S24 of forming the first surface electrode layer 22A by cooling the first plating layer.

The multilayer ceramic capacitor 1 according to the first example embodiment of the present invention is manufactured using the above-described manufacturing method, for example. The manufacturing method for the multilayer ceramic capacitor 1 according to the first example embodiment of the present invention is not limited to the above-described manufacturing method.

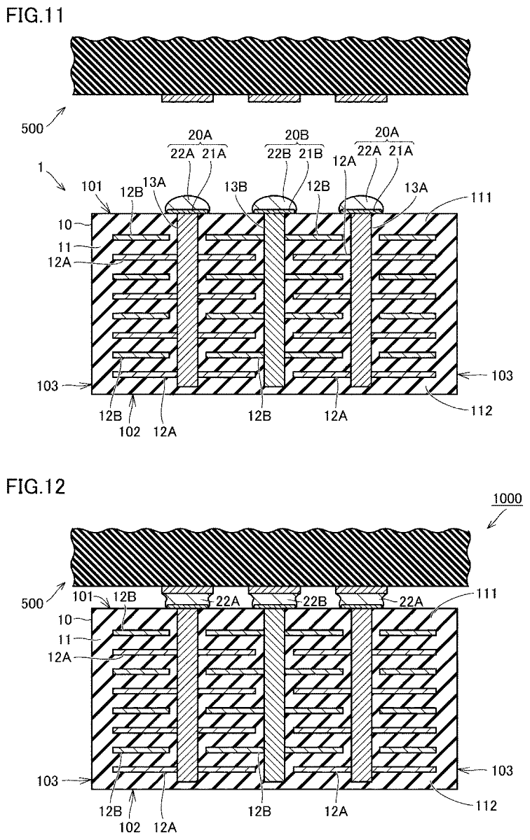

Next, an example of a manufacturing method for the mounting structure of the multilayer ceramic capacitor according to the first example embodiment of the present invention will be described. FIG. 11 is a schematic cross-sectional view showing a state where the multilayer ceramic capacitor according to the first example embodiment of the present invention and an electronic component are prepared. FIG. 12 is a schematic cross-sectional view showing the mounting structure of the multilayer ceramic capacitor according to the first example embodiment of the present invention.

As shown in FIGS. 11 and 12, the manufacturing method for the mounting structure of the multilayer ceramic capacitor includes a step of preparing the multilayer ceramic capacitor 1 manufactured using the above-described manufacturing method, and a step of electrically connecting the plurality of first surface electrode layers 22A of the multilayer ceramic capacitor 1 to an electronic component 500 by reflow soldering the plurality of first surface electrode layers 22A to the electronic component 500. As a result, the mounting structure 1000 of the multilayer ceramic capacitor is manufactured.

The manufacturing method for the mounting structure of the multilayer ceramic capacitor according to the present example embodiment further includes a step of electrically connecting the plurality of second surface electrode layers 22B to the electronic component 500 by reflow soldering the plurality of second surface electrode layers 22B to the electronic component 500. The step can be performed at the same time with the step of reflow soldering the first surface electrode layers 22A.

The plurality of first surface electrode layers 22A and the plurality of second surface electrode layers 22B, manufactured using the manufacturing method for the multilayer ceramic capacitor according to the present example embodiment, are formed such that the thickness of the central portion in the plane direction DP is relatively large, as described above. For this reason, reflow soldering of the plurality of first surface electrode layers 22A and the plurality of second surface electrode layers 22B is easy. Therefore, the multilayer ceramic capacitor 1 can be more easily mounted to the electronic component 500, so the mounting structure 1000 of the multilayer ceramic capacitor can be more easily manufactured.

As described above, the multilayer ceramic capacitor 1 according to the first example embodiment of the present invention includes the capacitor body 10, the first outer electrode 20A, and the second outer electrode 20B. The capacitor body 10 includes the dielectric layer 11, the plurality of first internal electrode layers 12A, the plurality of second internal electrode layers 12B, the first via conductor 13A, and the second via conductor 13B. The plurality of first internal electrode layers 12A and the plurality of second internal electrode layers 12B are alternately laminated in the lamination direction DS with the dielectric layer 11 interposed between adjacent ones of the first internal electrode layers 12A and the second internal electrode layers 12B. The first via conductor 13A is electrically connected to the plurality of first internal electrode layers 12A. The first via conductor 13A extends from the inside of the capacitor body 10 to the first main surface 101. The first main surface 101 is one side surface of the capacitor body 10 in the lamination direction DS. The second via conductor 13B is electrically connected to the plurality of second internal electrode layers 12B. The second via conductor 13B extends from the inside of the capacitor body 10 to the first main surface 101. The first outer electrode 20A includes the first base electrode layer 21A and the first surface electrode layer 22A. The first base electrode layer 21A is provided on the first main surface 101 so as to cover the first via conductor 13A. The first surface electrode layer 22A directly covers the first base electrode layer 21A. The second outer electrode 20B is provided on the first main surface 101 so as to cover the second via conductor 13B and is spaced apart from the first outer electrode 20A. The outer surface 221A of the first surface electrode layer 22A extends from the edge 21AE of the first base electrode layer 21A on the first main surface 101 away from the first main surface 101.

With the above configuration, in the vicinity of the edge 21AE of the first base electrode layer 21A, the thickness of the first surface electrode layer 22A in the plane direction DP orthogonal or substantially orthogonal to the lamination direction DS is relatively small. Therefore, the center distance between the first outer electrode 20A and the second outer electrode 20B in the plane direction DP can be designed to be reduced, and, by extension, the distance between the first via conductor 13A and the second via conductor 13B can be reduced. If the distance between the first via conductor 13A and the second via conductor 13B can be reduced, the magnetic field induced by current flowing through the first via conductor 13A and the magnetic field induced by current flowing through the second via conductor 13B more easily cancel each other out.

Therefore, with the above configuration, it is possible to reduce the equivalent series inductance (ESL) of the multilayer ceramic capacitor 1.

In the present example embodiment, the thickness T1 of the first surface electrode layer 22A in the lamination direction DS at the central portion in the plane direction DP parallel or substantially parallel to the first main surface 101 is greater than the average thickness of the first surface electrode layer 22A that is the average of thickness of the first surface electrode layer 22A from the inner surface 222A, which is the surface in contact with the first base electrode layer 21A, to the outer surface 221A.

With the above configuration, the thickness T1 of the first surface electrode layer 22A in the lamination direction DS is relatively large. When the thus configured multilayer ceramic capacitor 1 is mounted onto the electronic component 500, the distance between the capacitor body 10 and the electronic component 500 can be relatively increased when the first surface electrode layer 22A is reflow soldered to the electronic component 500. Therefore, an underfill resin for filling the gap between the capacitor body 10 and the electronic component 500 can be easily provided in that gap.

In the present example embodiment, the outer surface 221A of the first surface electrode layer 22A includes the first region 221Ap and the second region 221Aq in the lamination direction DS. The first region 221Ap is in contact with the edge 21AE. The second region 221Aq is located on the opposite side of the first region 221Ap from the first main surface 101. The first region 221Ap extends such that the cross-sectional area of the first outer electrode 20A when viewed in the lamination direction DS increases with increasing distance from the first main surface 101. The second region 221Aq extends such that the cross-sectional area of the first outer electrode 20A when viewed in the lamination direction DS decreases with increasing distance from the first main surface 101.

With the above configuration, an excessive reduction in the thickness of the first surface electrode layer 22A from the inner surface 222A to the outer surface 221A in the first region 221Ap can be reduced or prevented, so the strength of the first surface electrode layer 22A can be ensured. In the second region 221Aq, the dimensions of the first surface electrode layer 22A in the plane direction DP can be reduced. As a result, the center distance between the first outer electrode 20A and the second outer electrode 20B in the plane direction DP can be further reduced. By extension, the distance between the first via conductor 13A and the second via conductor 13B can be further reduced, with the result that the equivalent series inductance (ESL) of the multilayer ceramic capacitor 1 can be further reduced.

In the present example embodiment, the first via conductor 13A and the second via conductor 13B are not exposed from the second main surface 102 that is a surface opposite to the first main surface 101 in the capacitor body 10.

With the above configuration, a short circuit between the multilayer ceramic capacitor 1 and other electronic components disposed on the second main surface 102 side of the multilayer ceramic capacitor 1 can be reduced or prevented.

Furthermore, the example of the manufacturing method for the multilayer ceramic capacitor according to the first example embodiment of the present invention includes preparing the capacitor body 10 that includes the dielectric layer 11, the plurality of first internal electrode layers 12A, the plurality of second internal electrode layers 12B, the first via conductor 13A, and the second via conductor 13B, in which the plurality of first internal electrode layers 12A and the plurality of second internal electrode layers 12B are alternately laminated in the lamination direction DS with the dielectric layer 11 interposed between adjacent ones of the first internal electrode layers 12A and the second internal electrode layers 12B, the first via conductor 13A is electrically connected to the plurality of first internal electrode layers 12A and extends from the inside of the capacitor body 10 to the first main surface 101 that is the one-side surface of the capacitor body 10 in the lamination direction DS, and the second via conductor 13B is electrically connected to the plurality of second internal electrode layers 12B and extends from the inside of the capacitor body 10 to the first main surface 101, providing the first outer electrode 20A including the first base electrode layer 21A formed on the first main surface 101 so as to cover the first via conductor 13A and the first surface electrode layer 22A directly covering the first base electrode layer 21A, and providing the second outer electrode 20B on the first main surface 101 so as to cover the second via conductor 13B, the second outer electrode 20B being spaced apart from the first outer electrode 20A. The providing the first outer electrode 20A includes forming the first base electrode layer 21A, forming the first plating layer 30A on the first base electrode layer 21A by plating, heat-melting the first plating layer 30A, and forming the first surface electrode layer 22A by cooling the heat-melted first plating layer 30A.

With the above configuration, the outer surface of the first plating layer 30A deforms into a substantially spherical shape by heat-melting the first plating layer 30A. By cooling the first plating layer 30A deformed by heat-melting to form the first surface electrode layer 22A, the dimension of the first surface electrode layer 22A in the plane direction DP is less than the dimension of the first plating layer 30A in the plane direction DP. Therefore, the center distance between the first outer electrode 20A and the second outer electrode 20B in the plane direction DP can be designed to be reduced, and, by extension, the distance between the first via conductor 13A and the second via conductor 13B can be reduced. If the distance between the first via conductor 13A and the second via conductor 13B can be reduced, the magnetic field induced by current flowing through the first via conductor 13A and the magnetic field induced by current flowing through the second via conductor 13B more easily cancel each other out.

Therefore, with the above configuration, it is possible to reduce the equivalent series inductance (ESL) of the multilayer ceramic capacitor 1.

Furthermore, by cooling the first plating layer 30A deformed by heat-melting to form the first surface electrode layer 22A, the thickness T1 of the first surface electrode layer 22A at the central portion is greater than the thickness Tp1 of the first plating layer 30A at the central portion. When the multilayer ceramic capacitor 1 manufactured with the above configuration is mounted onto the electronic component 500, the distance between the capacitor body 10 and the electronic component 500 can be relatively increased when the first surface electrode layer 22A is reflow soldered to the electronic component 500. Therefore, an underfill resin for filling the gap between the capacitor body 10 and the electronic component 500 can be easily provided in that gap.

The example of the manufacturing method for the mounting structure of the multilayer ceramic capacitor according to the first example embodiment of the present invention includes preparing the multilayer ceramic capacitor 1 manufactured using the above-described manufacturing method, and electrically connecting the first surface electrode layer 22A of the multilayer ceramic capacitor 1 to the electronic component 500 by reflow soldering the first surface electrode layer 22A to the electronic component 500.

With the above configuration, an underfill resin for filling the gap between the capacitor body 10 and the electronic component 500 can be easily provided in that gap.

Next, a multilayer ceramic capacitor according to a second example embodiment of the present invention will be described. The multilayer ceramic capacitor according to the second example embodiment of the present invention differs from the multilayer ceramic capacitor 1 according to the first example embodiment of the present invention in that a third outer electrode and a fourth outer electrode are further provided. For this reason, the description of the configuration and advantageous effects the same as or similar to those of the multilayer ceramic capacitor according to the first example embodiment of the present invention will not be repeated.

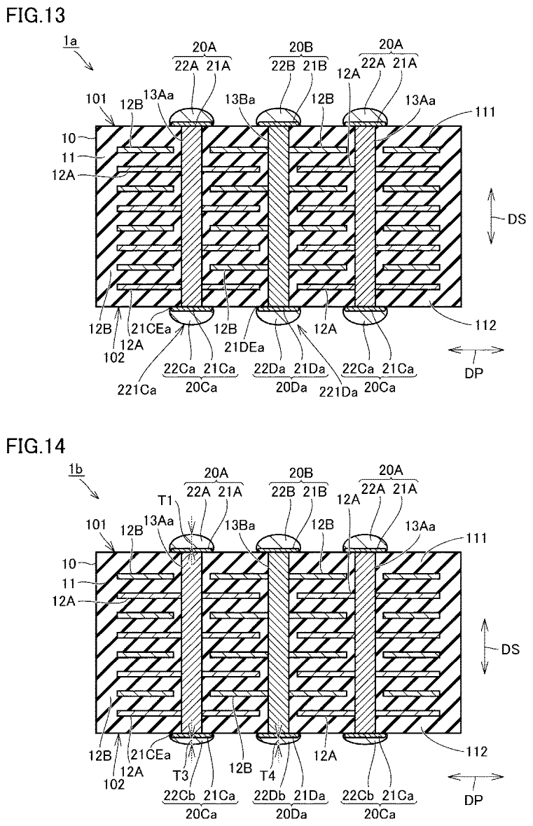

FIG. 13 is a cross-sectional view showing the multilayer ceramic capacitor according to the second example embodiment of the present invention. As shown in FIG. 13, the multilayer ceramic capacitor 1a further includes third outer electrodes 20Ca and fourth outer electrodes 20Da. The first via conductors 13Aa extend from the inside of the capacitor body 10 to the second main surface 102. The second via conductors 13Ba extend from the inside of the capacitor body 10 to the second main surface 102.

Each of the third outer electrodes 20Ca includes a third base electrode layer 21Ca and a third surface electrode layer 22Ca. The third base electrode layer 21Ca is provided on the second main surface 102 so as to cover any one of the first via conductor 13Aa and the second via conductor 13Ba. The third surface electrode layer 22Ca directly covers the third base electrode layer 21Ca.

Each of the fourth outer electrodes 20Da is provided on the second main surface 102 so as to cover any one of the first via conductor 13Aa and the second via conductor 13Ba and is spaced apart from the third outer electrode 20Ca.

An outer surface 221Ca of the third surface electrode layer 22Ca extends from an edge 21CEa of the third base electrode layer 21Ca on the second main surface 102 away from the second main surface 102.

With the above configuration, when outer electrodes are provided on the second main surface 102 side as well, the center distance between the third outer electrode 20Ca and the fourth outer electrode 20Da in the plane direction DP can be designed to be reduced, and, by extension, the distance between the first via conductor 13Aa and the second via conductor 13Ba can be reduced in order to reduce the equivalent series inductance (ESL) of the multilayer ceramic capacitor 1a.

The multilayer ceramic capacitor 1a according to the present example embodiment specifically includes the plurality of third outer electrodes 20Ca and the plurality of fourth outer electrodes 20Da. The plurality of third outer electrodes 20Ca are provided on the second main surface 102 so as to respectively cover the plurality of first via conductors 13Aa. The third base electrode layer 21Ca is provided on the second main surface 102 so as to cover the corresponding first via conductor 13Aa. In the present example embodiment, the third outer electrode 20Ca when viewed from the second main surface 102 can have the same or similar configuration as the first outer electrode 20A when viewed from the first main surface 101.

The plurality of fourth outer electrodes 20Da are provided on the second main surface 102 so as to respectively cover the plurality of second via conductors 13Ba. Each of the fourth outer electrodes 20Da includes a fourth base electrode layer 21Da and a fourth surface electrode layer 22Da. The fourth base electrode layer 21Da is provided on the second main surface 102 so as to cover the second via conductor 13Ba. The fourth surface electrode layer 22Da directly covers the fourth base electrode layer 21Da.

The outer surface 221Da of the fourth surface electrode layer 22Da also extends from an edge 21DEa of the fourth base electrode layer 21Da on the second main surface 102 away from the second main surface 102. In the present example embodiment, the fourth outer electrode 20Da when viewed from the second main surface 102 can have the same or similar configuration as the second outer electrode 20B when viewed from the first main surface 101.

An example of a manufacturing method for the multilayer ceramic capacitor according to the present example embodiment further includes a step of providing the third outer electrode 20Ca and a step of providing the fourth outer electrode 20Da. When viewed from the second main surface 102, the step of providing the third outer electrode 20Ca may have the same or similar configuration as the step S2 of providing the first outer electrode 20A when viewed from the first main surface 101. The step of providing the third outer electrode 20Ca may be performed simultaneously with the step S2 of providing the first outer electrode 20A. When viewed from the second main surface 102, the step of providing the fourth outer electrode 20Da can have the same or similar configuration as the step S3 of providing the second outer electrode 20B when viewed from the first main surface 101. The step of providing the fourth outer electrode 20Da may be performed simultaneously with the step S3 of providing the second outer electrode 20B.

In the present example embodiment, the step of providing the third outer electrode 20Ca and the step of providing the fourth outer electrode 20Da can be performed, for example, by clamping the capacitor body 10 with a jig so that each of the configurations for the third outer electrode 20Ca and the fourth outer electrode 20Da is not grounded. Furthermore, in the step S1 of preparing a capacitor body in the present example embodiment, the outer layer ceramic green sheets are not laminated onto the multilayer body in order for both sides of the columnar conductive paste in the lamination direction DS are not covered by the outer layer portions.

Next, a multilayer ceramic capacitor according to a third example embodiment of the present invention will be described. The multilayer ceramic capacitor according to the third example embodiment of the present invention differs from the multilayer ceramic capacitor according to the second example embodiment of the present invention in the shapes of the third surface electrode layer and fourth surface electrode layer. For this reason, the description of the configuration and advantageous effects the same as or similar to those of the multilayer ceramic capacitor according to the second example embodiment of the present invention will not be repeated.

FIG. 14 is a cross-sectional view showing a multilayer ceramic capacitor according to the third example embodiment of the present invention. As shown in FIG. 14, in the multilayer ceramic capacitor 1b according to the third example embodiment of the present invention, the thickness T3 of the third surface electrode layer 22Cb in the lamination direction DS at the central portion in the plane direction DP parallel or substantially parallel to the first main surface 101 is less than the thickness T1 of the first surface electrode layer 22A in the lamination direction DS at the central portion in the plane direction DP parallel or substantially parallel to the first main surface 101. With this configuration, the overall dimension of the multilayer ceramic capacitor 1b in the lamination direction DS can be relatively reduced.

In the present example embodiment, furthermore, the thickness T4 of the fourth surface electrode layer 22Db in the lamination direction DS at the central portion in the plane direction DP is less than the thickness T1 of the first surface electrode layer 22A in the lamination direction DS at the central portion in the plane direction DP parallel or substantially parallel to the first main surface 101.

In an example of a manufacturing method for the multilayer ceramic capacitor 1b according to the present example embodiment, in the step of heat-melting plating layers respectively provided on the base electrode layers to form the third surface electrode layer 22Cb and the fourth surface electrode layer 22Db, the plating layers are heat-melted in a state where the orientation of the capacitor body 10 is fixed such that the second main surface 102 of the capacitor body 10 faces upward in the vertical direction. As a result, the heat-melted plating layers deform so as to be crushed by their own weight, the relatively thin third surface electrode layer 22Cb and fourth surface electrode layer 22Db can be formed at the central portion. Alternatively, in the step of heat-melting the plating layers respectively provided on the base electrode layers to form the third surface electrode layer 22Cb and the fourth surface electrode layer 22Db, the relatively thin third surface electrode layer 22Cb and fourth surface electrode layer 22Db can be formed at the central portion by sucking a portion of the heat-melted plating layers.

Next, a multilayer ceramic capacitor according to a fourth example embodiment of the present invention, a manufacturing method therefor, and a manufacturing method for the mounting structure of the multilayer ceramic capacitor will be described. The multilayer ceramic capacitor according to the fourth example embodiment of the present invention differs from the multilayer ceramic capacitor 1 according to the first example embodiment of the present invention in the configuration of the first outer electrode and the second outer electrode. In the following description of the fourth example embodiment, the description of the configuration and advantageous effects the same as or similar to those of the multilayer ceramic capacitor 1 according to the first example embodiment of the present invention, the manufacturing method therefor, and the manufacturing method for the mounting structure of the multilayer ceramic capacitor will not be repeated.

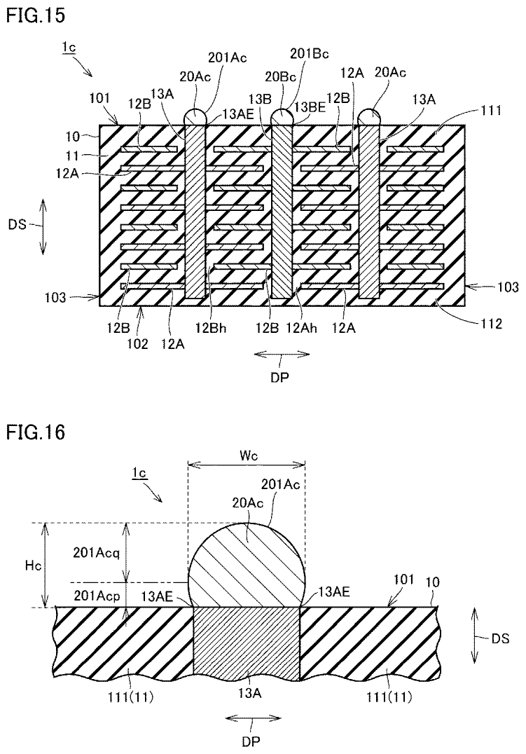

FIG. 15 is a cross-sectional view showing the multilayer ceramic capacitor according to the fourth example embodiment of the present invention. FIG. 16 is a partial cross-sectional view showing a first outer electrode and its surroundings of the multilayer ceramic capacitor according to the fourth example embodiment of the present invention.

As shown in FIGS. 15 and 16, in the multilayer ceramic capacitor 1c according to fourth example embodiment of the present invention, an outer surface 201Ac of a first outer electrode 20Ac extends from an edge 13AE of the first via conductor 13A on the first main surface 101 away from the first main surface 101.

With the above configuration, while the first outer electrode 20Ac covers the first via conductor 13A, the dimension of the first outer electrode 20Ac in the plane direction DP can be reduced in the vicinity of the edge 13AE of the first via conductor 13A. Therefore, the center distance between the first outer electrode 20Ac and the second outer electrode 20Bc in the plane direction DP can be designed to be reduced, and, by extension, the distance between the first via conductor 13A and the second via conductor 13B can be reduced. If the distance between the first via conductor 13A and the second via conductor 13B can be reduced, the magnetic field induced by current flowing through the first via conductor 13A and the magnetic field induced by current flowing through the second via conductor 13B more easily cancel each other out.

Therefore, with the above configuration, it is possible to reduce the equivalent series inductance (ESL) of the multilayer ceramic capacitor 1c.

In the present example embodiment, the outer surface 201Ac of the first outer electrode 20Ac includes a first region 201Acp and a second region 201Acq in the lamination direction DS. The first region 201Acp is in contact with the edge 13AE. The second region 201Acq is located on the opposite side of the first region 201Acp from the first main surface 101. The first region 201Acp extends such that the cross-sectional area of the first outer electrode 20Ac when viewed in the lamination direction DS increases with increasing distance from the first main surface 101. The second region 201Acq extends such that the cross-sectional area of the first outer electrode 20Ac when viewed in the lamination direction DS decreases with increasing distance from the first main surface 101.

With the above configuration, an excessive reduction in the dimension of the first outer electrode 20Ac in the plane direction DP in the first region 201Acp can be reduced or prevented, so the strength of the first outer electrode 20Ac can be ensured. In the second region 201Acq, the dimension of the first outer electrode 20Ac in the plane direction DP can be reduced. As a result, the center distance between the first outer electrode 20Ac and the second outer electrode 20Bc in the plane direction DP can be further reduced. By extension, the distance between the first via conductor 13A and the second via conductor 13B can be further reduced, with the result that the equivalent series inductance (ESL) of the multilayer ceramic capacitor 1c can be further reduced.

The first outer electrode 20Ac and the second outer electrode 20Bc in the fourth example embodiment of the present invention will be described in detail below.

The outer surface 201Ac of the first outer electrode 20Ac, more specifically, extends in a substantially curved shape, and, more specifically, extends in a substantially spherical shape. The height dimension Hc of the first outer electrode 20Ac in the lamination direction DS is, for example, greater than or equal to about 10 μm and less than or equal to about 20 μm. As the height dimension Hc of the first outer electrode 20Ac increases, the distance between the capacitor body 10 and an electronic component can be increased when the first outer electrode 20Ac is reflow soldered to the electronic component. Therefore, by setting the height dimension Hc greater than or equal to about 10 μm, an underfill resin for filling the gap between the capacitor body 10 and the electronic component can be easily injected into the gap. The upper limit of the height dimension Hc of the first outer electrode 20Ac is not limited. However, the height dimension Hc of the first outer electrode 20Ac is not limited to the above range.

The width dimension Wc, which is the maximum dimension in the plane direction DP, of the first outer electrode 20Ac is set as needed so as to correspond to the dimension of the first via conductor 13A in the plane direction DP. The above width dimension Wc is, for example, less than or equal to about 120 μm, preferably less than or equal to about 100 μm, or more preferably less than or equal to about 75 μm. As the width dimension Wc of the first outer electrode 20Ac reduces, the center distance between the first outer electrode 20Ac and the second outer electrode 20Bc in the plane direction DP can be designed to be reduced. The lower limit of the width dimension Wc of the first outer electrode 20Ac is not set. However, the width dimension Wc may be, for example, greater than or equal to about 30 μm or may be greater than or equal to about 50 μm.

The ratio (Wc/Hc) that is a value obtained by dividing the width dimension Wc by the height dimension Hc of the first outer electrode 20Ac is preferably, for example, lower than or equal to about 3.0, or more preferably lower than or equal to about 1.5. As the ratio (Wc/Hc) decreases, the center distance between the first outer electrode 20Ac and the second outer electrode 20Bc in the plane direction DP can be designed to be reduced, and the distance between the capacitor body 10 and an electronic component can be increased when the first outer electrode 20Ac is reflow soldered to the electronic component.

Each of the plurality of first outer electrodes 20Ac includes a single component. The plurality of first outer electrodes 20Ac are preferably made of a material having a melting point lower than the melting point of the material of the first via conductor 13A. As a result, it is easier to form the first surface electrode layer 22A into the above-described shape (details will be described later). The first outer electrode 20Ac is preferably made of, for example, Sn or an alloy including Sn and a metal such as Ag.

An outer surface 201Bc of the second outer electrode 20Bc extends from an edge 13BE of the corresponding second via conductor 13B on the first main surface 101 away from the first main surface 101. In this way, the second outer electrode 20Bc when viewed from the corresponding second via conductor 13B can have the same or similar configuration as the first outer electrode 20Ac when viewed from the corresponding first via conductor 13A.

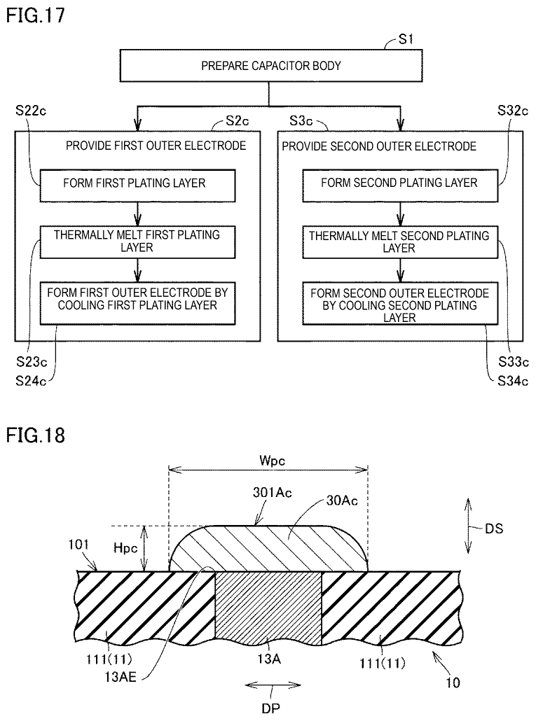

Next, an example of a manufacturing method for the multilayer ceramic capacitor according to the fourth example embodiment of the present invention will be described. FIG. 17 is a flowchart showing the manufacturing method for the multilayer ceramic capacitor according to the fourth example embodiment of the present invention. FIG. 18 is a schematic cross-sectional view showing a state immediately after a first plating layer is formed in the manufacturing method for the multilayer ceramic capacitor according to the fourth example embodiment of the present invention.

As shown in FIGS. 17 and 18, in the manufacturing method for the multilayer ceramic capacitor according to the fourth example embodiment of the present invention, the providing the first outer electrode 20Ac (S2c) includes forming the first plating layer 30Ac on the first via conductor 13A on the first main surface 101 by plating (S22c), heat-melting the first plating layer 30Ac (S23c), and forming the first outer electrode 20Ac by cooling the heat-melted first plating layer 30Ac (S24c).

With the above configuration, the outer surface of the first plating layer 30Ac deforms into a substantially spherical shape by heat-melting the first plating layer 30Ac. By cooling the first plating layer 30Ac deformed by heat-melting to form the first outer electrode 20Ac, the width dimension Wc of the first outer electrode 20Ac is less than the width dimension Wpc that is the maximum dimension of the first plating layer 30Ac in the plane direction DP. Therefore, the center distance between the first outer electrode 20Ac and the second outer electrode 20Bc in the plane direction DP can be designed to be reduced, and, by extension, the distance between the first via conductor 13A and the second via conductor 13B can be reduced. If the distance between the first via conductor 13A and the second via conductor 13B can be reduced, the magnetic field induced by current flowing through the first via conductor 13A and the magnetic field induced by current flowing through the second via conductor 13B more easily cancel each other out.

Therefore, with the above configuration, the distance between the first via conductor 13A and the second via conductor 13B can be reduced, with the result that the equivalent series inductance (ESL) of the multilayer ceramic capacitor 1c can be reduced.

Furthermore, by cooling the first plating layer 30Ac deformed by heat-melting to form the first outer electrode 20Ac, the height dimension Hc of the first outer electrode 20Ac is greater than the height dimension Hpc of the first plating layer 30A. When the multilayer ceramic capacitor 1c manufactured with the above configuration is mounted onto an electronic component, the distance between the capacitor body 10 and the electronic component can be relatively increased when the first outer electrode 20Ac is reflow soldered to the electronic component. Therefore, an underfill resin for filling the gap between the capacitor body 10 and the electronic component can be easily provided in that gap.

The example of the manufacturing method for the multilayer ceramic capacitor according to the fourth example embodiment of the present invention will be described in more detail. As shown in FIG. 17, in the present example embodiment, the step S2c of providing a first outer electrode includes a step S22c of forming a first plating layer, a step S23c of heat-melting the first plating layer, and a step S24c of forming a first outer electrode by cooling the first plating layer.

As shown in FIG. 18, in the step S22c of forming a first plating layer, the first plating layer 30Ac is formed by performing plating treatment on the first via conductor 13A. The plating treatment may be, for example, plating treatment using barrel plating. The first plating layer 30Ac grows also in the plane direction DP during plating treatment. For this reason, the first plating layer 30Ac is provided so as to cover the boundary between the dielectric layer 11 (first outer layer portion 111) and the first via conductor 13A.

In the step S23c of heat-melting the first plating layer, the first plating layer 30Ac formed as described above is heat-melted. As a result, the melted first plating layer 30Ac deforms into a curved shape due to its surface tension such that the area of the outer surface 301Ac approaches the minimum area for the volume of the first plating layer 30Ac, and more specifically deforms into a substantially spherical shape. The height dimension Hpc of the first plating layer 30Ac increases due to the deformation. On the other hand, the width dimension Wpc of the first plating layer 30Ac reduces due to the deformation. The bonding strength between the first plating layer 30Ac and the first outer layer portion 111 is relatively low, and the bonding strength between the first plating layer 30Ac and the first via conductor 13A is relatively high. For this reason, the outer surface 301Ac of the first plating layer 30Ac deforms so as to extend from the edge 13AE of the first via conductor 13A on the first main surface 101 relative to the first main surface 101.

Then, in the step S24c of forming a first outer electrode by cooling the first plating layer, the first plating layer 30Ac melted and deformed as described above is cooled and solidified. As a result, the first outer electrode 20Ac, as shown in FIGS. 15 and 16, is formed. Therefore, the height dimension Hc, width dimension Wc, and the like, of the first outer electrode 20Ac can be controlled by adjusting the height dimension Hpc of the first plating layer 30Ac.

Therefore, in the present example embodiment, the width dimension Wc of the first outer electrode 20Ac is less than the width dimension Wpc of the first plating layer 30Ac before being heat-melted. The height dimension Hc of the first outer electrode 20Ac is greater than the height dimension Hpc of the first plating layer 30Ac before being heat-melted. The ratio (Wc/Hc) of the first outer electrode 20Ac is lower than the ratio (Wpc/Hpc) of the first plating layer 30A before being heat-melted.

As shown in FIG. 17, in the present example embodiment, the step S3c of providing a second outer electrode includes a step S32c of forming a second plating layer, a step S33c of heat-melting the second plating layer, and a step S34c of forming a second outer electrode by cooling the second plating layer. The step S32c of forming a second plating layer is performed at the same time with the step S22c of forming a first plating layer. The step S33c of heat-melting the second plating layer is performed at the same time with the step S23c of heat-melting the first plating layer. The step S34c of forming a second surface electrode layer by cooling the second plating layer is performed at the same time with the step S24c of forming a first surface electrode layer by cooling the first plating layer.

The same method as the example of the method of forming the first outer electrode 20Ac when viewed from the first via conductor 13A can be used as a method of forming the second outer electrode 20Bc when viewed from the corresponding second via conductor 13B. Specifically, in the step S32c of forming a second plating layer, a second plating layer can be formed on the second via conductor 13B in the same or substantially the same manner as the method of forming the first plating layer 30A on the first via conductor 13A. Heating conditions of the step S33c of heat-melting the second plating layer may be the same or substantially the same as heating conditions of the step S23c of heat-melting the first plating layer. As a result, the second plating layer also deforms similarly to the first plating layer 30Ac. Conditions for cooling the heat-melted second plating layer in the step S34c of forming the second outer electrode 20Bc by cooling the second plating layer may be the same or substantially the same as cooling conditions in the step S24 of forming the first outer electrode 20Ac by cooling the first plating layer.

The multilayer ceramic capacitor 1c according to the fourth example embodiment of the present invention is manufactured using the above-described manufacturing method. The manufacturing method for the multilayer ceramic capacitor 1c according to the fourth example embodiment of the present invention is not limited to the above-described manufacturing method.

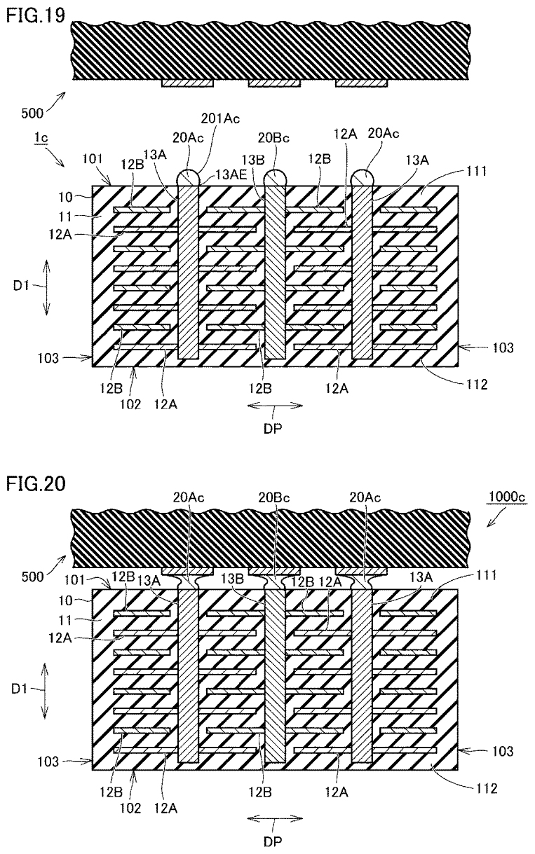

FIG. 19 is a schematic cross-sectional view showing a state where the multilayer ceramic capacitor according to the fourth example embodiment of the present invention and an electronic component are prepared. FIG. 20 is a schematic cross-sectional view showing the mounting structure of the multilayer ceramic capacitor according to the fourth example embodiment of the present invention.

As shown in FIGS. 19 and 20, an example of a manufacturing method for the mounting structure of the multilayer ceramic capacitor according to fourth example embodiment of the present invention includes a step of preparing the multilayer ceramic capacitor 1c manufactured using the above-described manufacturing method for the multilayer ceramic capacitor, and a step of electrically connecting the first outer electrodes 20Ac of the multilayer ceramic capacitor 1c to the electronic component 500 by reflow soldering the first outer electrodes 20Ac to the electronic component 500.

With the above configuration, the mounting structure 1000c of the multilayer ceramic capacitor is manufactured. With the above configuration, an underfill resin for filling the gap between the capacitor body 10 and the electronic component 500 can be easily provided in that gap.

The example of the manufacturing method for the mounting structure of the multilayer ceramic capacitor according to the present example embodiment further includes a step of electrically connecting the second outer electrodes 20Bc to the electronic component 500 by reflow soldering the second outer electrodes 20Bc to the electronic component 500. The step can be performed at the same time with the step of reflow soldering the first outer electrodes 20Ac.

In the description of the example embodiments and examples described above, combinable configurations may be combined with each other.

The example embodiments described above are illustrative in all respects and not restrictive. The scope of the present invention is recited not in the above description but in the claims. The present invention encompasses all modifications within the meaning and scope of equivalents of the scope of the claims.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic capacitor comprising:
a capacitor body;
a first outer electrode; and
a second outer electrode; wherein
the capacitor body includes:
a dielectric layer;
first internal electrode layers and second internal electrode layers alternately laminated in a lamination direction with the dielectric layer interposed between adjacent ones of the first internal electrode layers and the second internal electrode layers;
a first via conductor electrically connected to the first internal electrode layers and extending from an inside of the capacitor body to a first main surface of the capacitor body in the lamination direction; and
a second via conductor electrically connected to the second internal electrode layers and extending from the inside of the capacitor body to the first main surface;
the first outer electrode includes:
a first base electrode layer on the first main surface and covering the first via conductor; and
a first surface electrode layer directly covering the first base electrode layer;
the second outer electrode is located on the first main surface, covers the second via conductor, and spaced apart from the first outer electrode; and
an outer surface of the first surface electrode layer extends from an edge of the first base electrode layer on the first main surface in a direction away from the first main surface.

2. The multilayer ceramic capacitor according to claim 1, wherein a thickness of the first surface electrode layer in the lamination direction at a central portion in a plane direction parallel or substantially parallel to the first main surface is greater than an average thickness of the first surface electrode layer that is an average of thickness of the first surface electrode layer from an inner surface in contact with the first base electrode layer to the outer surface.

3. The multilayer ceramic capacitor according to claim 1, wherein
the outer surface of the first surface electrode layer includes a first region in contact with the edge and a second region on an opposite side of the first region from the first main surface, in the lamination direction;
the first region extends such that a cross-sectional area of the first outer electrode when viewed in the lamination direction increases with increasing distance from the first main surface; and
the second region extends such that the cross-sectional area of the first outer electrode when viewed in the lamination direction decreases with increasing distance from the first main surface.

4. The multilayer ceramic capacitor according to claim 1, wherein the first via conductor and the second via conductor are not exposed from a second main surface opposite to the first main surface in the capacitor body.

5. The multilayer ceramic capacitor according to claim 1, further comprising:
a third outer electrode; and
a fourth outer electrode; wherein
the first via conductor extends from the inside of the capacitor body to a second main surface opposite to the first main surface in the capacitor body;
the second via conductor extends from the inside of the capacitor body to the second main surface;
the third outer electrode includes:
a third base electrode layer on the second main surface and covering one of the first via conductor and the second via conductor; and
a third surface electrode layer directly covering the third base electrode layer;
the fourth outer electrode is located on the second main surface, covers the other one of the first via conductor and the second via conductor, and is spaced apart from the third outer electrode; and
an outer surface of the third surface electrode layer extends from an edge of the third base electrode layer on the second main surface in a direction away from the second main surface.

6. The multilayer ceramic capacitor according to claim 5, wherein a thickness of the third surface electrode layer in the lamination direction at a central portion in a plane direction parallel or substantially parallel to the first main surface is less than a thickness of the first surface electrode layer in the lamination direction at a central portion in the plane direction parallel or substantially parallel to the first main surface.

7. The multilayer ceramic capacitor according to claim 1, wherein the dielectric layer includes BaTiO₃, CaTiO₃, SrTiO₃, SrZrO₃, or CaZrO₃, as a main component.

8. The multilayer ceramic capacitor according to claim 1, wherein each of the first and second internal electrode layers includes Ni, Cu, Ag, Pd, Pt, Fe, Ti, Cr, Sn, or Au, or an alloy including at least one of Ni, Cu, Ag, Pd, Pt, Fe, Ti, Cr, Sn, or Au.

9. The multilayer ceramic capacitor according to claim 1, wherein a thickness of each of the first and second internal electrode layers is greater than or equal to about 0.3 μm and less than or equal to about 1.0 μm.

10. The multilayer ceramic capacitor according to claim 1, wherein the first base electrode layer includes a first electrode layer.

11. A manufacturing method for a multilayer ceramic capacitor, the manufacturing method comprising:
preparing a capacitor body including a dielectric layer, first internal electrode layers, second internal electrode layers, a first via conductor, and a second via conductor, wherein the first internal electrode layers and the second internal electrode layers are alternately laminated in a lamination direction with the dielectric layer interposed between adjacent ones of the first internal electrode layers and the second internal electrode layers, the first via conductor is electrically connected to the first internal electrode layers and extends from an inside of the capacitor body to a first main surface of the capacitor body in the lamination direction, and the second via conductor is electrically connected to the second internal electrode layers and extends from the inside of the capacitor body to the first main surface;
providing a first outer electrode including a first base electrode layer on the first main surface so as to cover the first via conductor and a first surface electrode layer directly covering the first base electrode layer; and
providing a second outer electrode on the first main surface so as to cover the second via conductor, the second outer electrode being spaced apart from the first outer electrode; wherein
the providing the first outer electrode includes:
forming the first base electrode layer;
forming a first plating layer on the first base electrode layer by plating;
heat-melting the first plating layer; and
forming the first surface electrode layer by cooling the heat-melted first plating layer.

12. The manufacturing method according to claim 11, wherein a thickness of the first surface electrode layer in the lamination direction at a central portion in a plane direction parallel or substantially parallel to the first main surface is greater than an average thickness of the first surface electrode layer that is an average of thickness of the first surface electrode layer from an inner surface in contact with the first base electrode layer to an outer surface.

13. A manufacturing method for a mounting structure of a multilayer ceramic capacitor, the manufacturing method comprising:
preparing a multilayer ceramic capacitor manufactured using the manufacturing method for a multilayer ceramic capacitor according to claim 11; and
electrically connecting the first surface electrode layer to an electronic component of the multilayer ceramic capacitor by reflow soldering the first surface electrode layer to the electronic component.

14. A multilayer ceramic capacitor comprising:
a capacitor body;
a first outer electrode; and
a second outer electrode; wherein
the capacitor body includes:
a dielectric layer;
first internal electrode layers and second internal electrode layers alternately laminated in a lamination direction with the dielectric layer interposed between adjacent ones of the first internal electrode layers and the second internal electrode layers;
a first via conductor electrically connected to the first internal electrode layers and extending from an inside of the capacitor body to a first main surface of the capacitor body in the lamination direction; and
a second via conductor electrically connected to the plurality of second internal electrode layers and extending from the inside of the capacitor body to the first main surface;
the first outer electrode is located on the first main surface and covers the first via conductor;
the second outer electrode is located on the first main surface, covers the second via conductor, and is spaced apart from the first outer electrode; and
an outer surface of the first outer electrode extends from an edge of the first via conductor on the first main surface in a direction away from the first main surface.

15. The multilayer ceramic capacitor according to claim 14, wherein
the outer surface of the first outer electrode includes a first region in contact with the edge and a second region located on an opposite side of the first region from the first main surface, in the lamination direction;
the first region extends such that a cross-sectional area of the first outer electrode when viewed in the lamination direction increases with increasing distance from the first main surface; and
the second region extends such that the cross-sectional area of the first outer electrode when viewed in the lamination direction decreases with increasing distance from the first main surface.

16. The multilayer ceramic capacitor according to claim 14, wherein each of the first and second internal electrode layers includes Ni, Cu, Ag, Pd, Pt, Fe, Ti, Cr, Sn, or Au, or an alloy including at least one of Ni, Cu, Ag, Pd, Pt, Fe, Ti, Cr, Sn, or Au.

17. The multilayer ceramic capacitor according to claim 14, wherein a thickness of each of the first and second internal electrode layers is greater than or equal to about 0.3 μm and less than or equal to about 1.0 μm.

18. The multilayer ceramic capacitor according to claim 14, wherein the first base electrode layer includes a first electrode layer.

19. A manufacturing method for a multilayer ceramic capacitor, the manufacturing method comprising:
preparing a capacitor body including a dielectric layer, first internal electrode layers, second internal electrode layers, a first via conductor, and a second via conductor, wherein the first internal electrode layers and the second internal electrode layers are alternately laminated in a lamination direction with the dielectric layer interposed between adjacent ones of the first internal electrode layers and the second internal electrode layers, the first via conductor is electrically connected to the first internal electrode layers and extends from an inside of the capacitor body to a first main surface of the capacitor body in the lamination direction, and the second via conductor is electrically connected to the second internal electrode layers and extends from the inside of the capacitor body to the first main surface;
providing a first outer electrode on the first main surface so as to cover the first via conductor; and
providing a second outer electrode on the first main surface so as to cover the second via conductor, the second outer electrode being spaced apart from the first outer electrode; wherein
the providing the first outer electrode includes:
forming a first plating layer on the first via conductor on the first main surface by plating;
heat-melting the first plating layer; and
forming the first outer electrode by cooling the heat-melted first plating layer.

20. A manufacturing method for a mounting structure of a multilayer ceramic capacitor, the manufacturing method comprising:
preparing a multilayer ceramic capacitor manufactured using the manufacturing method for a multilayer ceramic capacitor according to claim 19; and
electrically connecting the first outer electrode of the multilayer ceramic capacitor to an electronic component by reflow soldering the first outer electrode to the electronic component.
